(19) United States
(12) Patent Application Publication
(10) Pub. No.: US 2025/0216077 A1
(43) Pub. Date: Jul. 3, 2025

(54) ADDITIVELY MANUFACTURED TAPERED TRANSITION PORTION AND AFT FRAME FOR REPLACEMENT OF EXISTING COMBUSTOR PARTS

(71) Applicant: GE Infrastructure Technology LLC, Greenville, SC (US)

(72) Inventor: Richard Martin DiCintio, Simpsonville, SC (US)

(21) Appl. No.: 18/399,858

(22) Filed: Dec. 29, 2023

(51) Int. Cl. F23R 3/00; B22F 7/06; B22F 7/08; B22F 10/28; B22F 10/322; B22F 10/85; B22F 12/45; B22F 12/90; B33Y 10/00; B33Y 40/00; B33Y 50/02; B33Y 80/00; F02C 3/14

(52) U.S. Cl. CPC F23R 3/002; B22F 7/062; B22F 7/08; B22F 10/28; B33Y 10/00; B33Y 40/00; B33Y 80/00; F02C 3/14; B22F 2007/068; B22F 10/322; B22F 10/85; B22F 12/45; B22F 12/90; B22F 2998/10; B33Y 50/02

(57) ABSTRACT

A combustor for a gas turbine (GT) system includes a combustor body including a non-additively manufactured (non-AM) part having corrosion at a first level and a replacement additively manufactured (AM) part coupled to the non-AM part. The replacement AM part has corrosion at a second level less than the first level. The replacement AM part includes at least an aft section of a tapered transition portion and an aft frame of the combustor body, and a plurality of shared parallel, sintered metal layers extending into the aft section of the tapered transition portion and the aft frame. The replacement AM part may also include a receiving element in a forwardmost end thereof configured to receive a rearwardmost remaining end of the non-AM part. The replacement AM part may also optionally include an AFS injector mount and part of a cylindrical portion of a combustion liner.

### TECHNICAL FIELD

The disclosure relates generally to turbomachine combustors and, more specifically, to an additively manufactured part including at least an aft section of a tapered transition portion of a combustion liner and an aft frame for replacing existing part(s) of a combustor body.

### BACKGROUND

Gas turbine systems include a combustion section including a plurality of combustors in which fuel is combusted to create a flow of combustion gas that is converted to kinetic energy in a downstream turbine section. Current combustors include a large number of parts that need to be welded together. For example, a combustor body may include a combustion liner having a cylindrical portion and a tapered transition portion with an aft frame at an aft end of the tapered transition portion. The cylindrical portion and the tapered transition portion may be made of stamped metal, and the aft frame may be cast. The aft frame couples the tapered transition portion to a turbine inlet and is welded to the aft end of the tapered transition portion. The weld represents one example of a plurality of life-limiting structures in the combustor body. Current approaches to repairing or replacing the tapered transition portion and/or aft frame typically include replacing each part individually with the same structure and materials, including the life-limiting weld and other potentially life-limiting structures.

Additive manufacturing such as direct metal laser melting (DMLM) or selective laser melting (SLM) has emerged as a reliable manufacturing method for making combustor parts. It is understood that the size of the build platform and the size of the processing chamber limit the size of the combustor parts that may be manufactured using these techniques. Further, it may be appreciated that, because larger parts typically require longer build times, the use of additive manufacturing for large-scale combustor parts has not been readily adopted.

### BRIEF DESCRIPTION

All aspects, examples and features mentioned below can be combined in any technically possible way.

One aspect of the disclosure includes a method of repairing a combustor including a combustor body including a combustion liner including a cylindrical portion and a tapered transition portion, and an aft frame coupled to an aft end of the tapered transition portion, the method comprising: removing a non-additively manufactured (non-AM) part of the combustor body, creating a removed non-AM part and a remaining non-AM part of the combustor body, wherein the removed non-AM part includes at least an aft section of the tapered transition portion and the aft frame of the combustor body; additively manufacturing a replacement additively manufactured (AM) part for the removed non-AM part, the replacement AM part including a receiving element configured to receive part of the remaining non-AM part of the combustor body and a plurality of parallel, sintered metal layers; wherein the replacement AM part includes at least the aft section of the tapered transition portion and the aft frame of the combustor body; and coupling the replacement AM part to the remaining non-AM part of the combustor body.

Another aspect of the disclosure includes the preceding aspect, and the removed non-AM part includes at least one life-limiting structure selected from a group comprising: a weld, a hot spot, and a high stress geometry.

Another aspect of the disclosure includes any of the preceding aspects, and the coupling includes welding the replacement AM part to the remaining non-AM part of the combustor body where the remaining non-AM part meets the receiving element.

Another aspect of the disclosure includes any of the preceding aspects, and the replacement AM part includes at least one cooling passage defined therein.

Another aspect of the disclosure includes any of the preceding aspects, and the plurality of parallel, sintered metal layers in the replacement AM part extends into the aft section of the tapered transition portion and the aft frame.

Another aspect of the disclosure includes any of the preceding aspects, and the removed non-AM part further includes an axial fuel stage (AFS) injector mount upstream of the tapered transition portion; and wherein the replacement AM part further includes the AFS injector mount, and the plurality of parallel, sintered metal layers in the replacement AM part extends into the AFS injector mount.

Another aspect of the disclosure includes any of the preceding aspects, and the removed non-AM part further includes a part of the cylindrical portion of the combustion liner upstream of the AFS injector mount; and wherein the replacement AM part further includes the part of the cylindrical portion of the combustion liner, and the plurality of parallel, sintered metal layers in the replacement AM part extends into the part of the cylindrical portion of the combustion liner.

Another aspect of the disclosure includes any of the preceding aspects, and the removed non-AM part includes a first material, and the replacement AM part includes a second material different than the first material.

Another aspect of the disclosure includes a combustor for a gas turbine (GT) system, the combustor comprising: a combustor body including a combustion liner including a cylindrical portion and a tapered transition portion, an axial fuel stage (AFS) injector mount, and an aft frame at an aft end of the tapered transition portion, wherein the combustor body includes a first, non-additively manufactured (non-AM) part having corrosion at a first level and a second additively manufactured (AM) part coupled to the first non-AM part, the second AM part having corrosion at a second level less than the first level, wherein the second AM part includes at least an aft section of the tapered transition portion and the aft frame, and a plurality of shared parallel, sintered metal layers extending into the at least aft section of the tapered transition portion and the aft frame.

Another aspect of the disclosure includes any of the preceding aspects, and the second AM part includes a receiving element configured to receive part of the first non-AM part and join the first non-AM part and the second AM part.

Another aspect of the disclosure includes any of the preceding aspects, and further comprising a weld coupling the first non-AM part and the second AM part.

Another aspect of the disclosure includes any of the preceding aspects, and the first non-AM part includes a first material, and the second AM part includes a second material different than the first material.

Another aspect of the disclosure includes any of the preceding aspects, and the second AM part includes at least one cooling passage defined therein that was not present in the first non-AM part.

Another aspect of the disclosure includes any of the preceding aspects, and the second AM part further includes the AFS injector mount, and the plurality of parallel, sintered metal layers in the second AM part extends into the AFS injector mount.

Another aspect of the disclosure includes any of the preceding aspects, and the second AM part further includes a part of the cylindrical portion of the combustion liner, and the plurality of parallel, sintered metal layers in the second AM part extends into the part of the cylindrical portion of the combustion liner.

Another aspect of the disclosure includes a component for replacing a first non-additively manufactured (non-AM) part of a combustor body for a gas turbine (GT) system, the first non-AM part including at least an aft section of a tapered transition portion and an aft frame of the combustor body, the component comprising: a second additively manufactured (AM) part including at least the aft section of the tapered transition portion and the aft frame, and a receiving element in a forwardmost end of the second AM part configured to receive a rearwardmost remaining end of the combustor body after removal of the first non-AM part and join the rearwardmost remaining end of the combustor body and the forwardmost end of the second AM part.

Another aspect of the disclosure includes any of the preceding aspects, and further comprising a weld coupling a remaining portion of the combustor body and the second AM part.

Another aspect of the disclosure includes any of the preceding aspects, and the first non-AM part includes a first material, and the second AM part includes a second material different than the first material.

Another aspect of the disclosure includes any of the preceding aspects, and the replacement AM part further includes an axial fuel stage (AFS) injector mount of the combustor body upstream of the tapered transition portion; and wherein the plurality of parallel, sintered metal layers in the replacement AM part extends into the AFS injector mount.

Another aspect of the disclosure includes any of the preceding aspects, and the second AM part further includes a part of a cylindrical portion of a combustion liner of the combustor body upstream of the AFS injector mount; and wherein the plurality of parallel, sintered metal layers in the replacement AM part extends into the part of the cylindrical portion of the combustion liner.

Two or more aspects described in this disclosure, including those described in this summary section, may be combined to form implementations not specifically described herein. That is, all embodiments described herein can be combined with each other.

The details of one or more implementations are set forth in the accompanying drawings and the description below. Other features, objects and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a cross-sectional side view of a portion of a conventional combustor with a plurality of potentially life-limiting structures therein;

FIG. 2 shows a functional block diagram of an illustrative gas turbine system capable of use with a combustor and a component according to embodiments of the disclosure;

FIG. 3 shows a cross-sectional side view of a portion of a combustor with an additively manufactured replacement part according to embodiments of the disclosure;

FIG. 4 shows a cross-sectional perspective and exploded view of a remaining portion of a combustor body, a removed non-additively manufactured part, and a replacement additively manufactured part as in FIG. 3 according to embodiments of the disclosure;

FIG. 5A shows a cross-sectional side view of a portion of a combustor with an additively manufactured replacement part according to other embodiments of the disclosure;

FIG. 5B shows a cross-sectional side view of the additively manufactured replacement part in FIG. 5A according to other embodiments of the disclosure;

FIG. 6A shows a cross-sectional side view of a portion of a combustor with an additively manufactured replacement part according to other embodiments of the disclosure;

FIG. 6B shows a cross-sectional side view of the additively manufactured replacement part in FIG. 6A according to other embodiments of the disclosure; and

FIG. 7 shows a schematic block diagram of an illustrative additive manufacturing system for additively manufacturing a replacement part according to embodiments of the disclosure.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

As an initial matter, in order to clearly describe the current technology, it will become necessary to select certain terminology when referring to and describing relevant machine components within the illustrative application of a turbomachine. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this section. These terms and their definitions, unless stated otherwise, are as follows. As used herein, “downstream” and “upstream” are terms that indicate a direction relative to the flow of a fluid, such as the working fluid through a combustor of the turbomachine or, for example, the flow of air through the combustor or coolant through one of the turbomachine's component systems. The term “downstream” corresponds to the direction of flow of the fluid, and the term “upstream” refers to the direction opposite to the flow. The terms “forward” and “aft,” without any further specificity, refer to directions, with “forward” referring to the front or compressor end of the turbomachine, and “aft” referring to the rearward or turbine end of the turbomachine.

The term “axial” refers to movement or position parallel to an axis, e.g., an axis of a combustor or turbomachine. The term “radial” refers to movement or position perpendicular to an axis, e.g., an axis of a combustor or a turbomachine. In cases such as this, if a first component resides closer to the axis than a second component, it will be stated herein that the first component is “radially inward” or “inboard” of the second component. If, on the other hand, the first component resides further from the axis than the second component, it may be stated herein that the first component is “radially outward” or “outboard” of the second component. Finally, the term “circumferential” refers to movement or position around an axis, e.g., a circumferential interior surface of a combustion liner or a circumferential interior of casing extending about a combustor. As indicated above and depending on context, it will be appreciated that such terms may be applied in relation to the axis of the combustor or the axis of the turbomachine.

In addition, several descriptive terms may be used regularly herein, as described below. The terms “first,” “second,” and “third,” may be used interchangeably to distinguish one component from another and are not intended to signify location or importance of the individual components.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event may or may not occur or that the subsequently described feature may or may not be present and that the description includes instances where the event occurs, or the feature is present and instances where the event does not occur, or the feature is not present.

Where an element or layer is referred to as being “on,” “engaged to,” “connected to,” “coupled to,” or “mounted to” another element or layer, it may be directly on, engaged, connected, coupled, or mounted to the other element or layer, or intervening elements or layers may be present. In contrast, when an element is referred to as being “directly on,” “directly engaged to,” “directly connected to,” “directly coupled to,” or “directly mounted to” another element or layer, there are no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The verb forms of “couple” and “mount” may be used interchangeably herein.

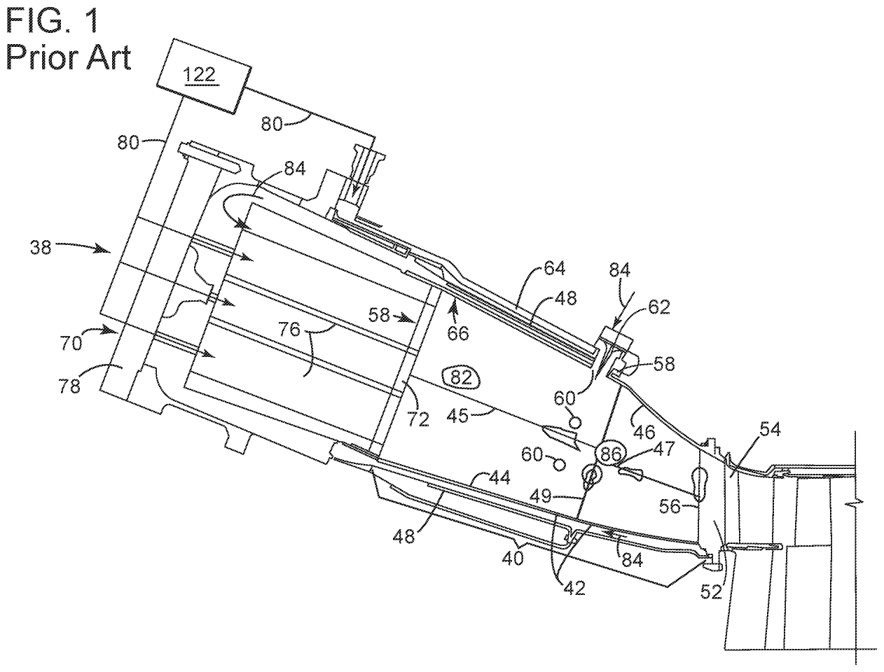

FIG. 1 shows a cross-sectional side view of a portion of a conventional combustor 38. Combustor 38 includes a combustor body 40 including a combustion liner 42 including a cylindrical portion 44 and a tapered transition portion 46. A flow sleeve 48 may surround at least cylindrical portion 44 of combustion liner 42. Cylindrical portion 44 and flow sleeve 48 are typically made of sheet material rolled or stamped into cylindrical or frustoconical shapes and welded together, as represented by weld 45 of cylindrical portion 44. Flow sleeve 48 is mounted about cylindrical portion 44 of combustion liner 42 and/or a tapered transition portion 46 of combustion liner 42 with mechanical couplers or welds. Cylindrical portion 44 of combustion liner 42 and flow sleeve 48 are coupled in a spaced manner to a head end assembly 70 of combustor 38 that includes one or more axially extending fuel nozzles 76.

Tapered transition portion 46 of combustion liner 42 is typically made by stamped and welded together metal sheets (see weld 47). Tapered transition portion 46 is welded to cylindrical portion 44, e.g., by weld 49. Aft frame 52 couples tapered transition portion 46 to a turbine inlet 54. Aft frame 52 is typically made by casting or another process. Aft frame 52 is welded at weld 56 to an aft end of tapered transition portion 46. Smaller parts such as axial fuel stage (AFS) fuel injector mounts 58 are made using other processes. Openings 60 are separately machined into combustion liner 42 for AFS injectors 62, and mounts 58 are then welded adjacent each opening 60 in combustion liner 42 so AFS injectors 62 can be bolted to mounts 58. Fuel lines 64 for AFS injectors 62 are mounted to an exterior of flow sleeve 48.

Combustion liner 42, also known as a hot gas path (HGP) duct or unibody liner, extends downstream from a head end fuel nozzle assembly 70 (hereafter “head end assembly 70”) and a cap assembly 72 coupled to an aft end of head end assembly 70 and/or a forward end 74 of combustor body 40. Head end assembly 70 generally includes at least one axially extending fuel nozzle 76 that extends downstream from an end cover 78 and cap assembly 72 that extends radially and axially within combustion liner 42 downstream from end cover 78 to define an upstream boundary of the combustion chamber. Head end assembly 70 may include any now known or later developed axially extending fuel nozzles 76 for delivering fuel 80 to a primary combustion zone 82 from axially extending fuel nozzles 76. Axially extending fuel nozzle(s) 76 of head end assembly 70 provide a combustible mixture of fuel 80 and compressed air 84 to primary combustion zone 82. AFS injectors 62 extend radially through combustion liner 42 downstream from axially extending fuel nozzle(s) 76. As will be further described herein, compressed air 84 may be routed to AFS injector(s) 62 to combine with fuel 80 for combustion in a secondary combustion zone 86 that is downstream from primary combustion zone 82.

As illustrated, each component of combustor 38 described may include a large number of sub-parts including, but not limited to, mounting fasteners or welds, heat or protective shields, seals, spacers, and couplers. The parts of combustor body 40 may include any now known or later developed combustion tolerant and oxidation resistant materials. The material may include but is not limited to: an austenite nickel-chromium based alloy such as Inconel 625 or 718, a nickel-chromium-cobalt-molybdenum alloy (NiCrCoMo) (e.g., HA282 or HA233 from Haynes International, Inc.), a nickel-chromium-iron-molybdenum alloy (NiCrFeMo) (e.g., Hastelloy X from Haynes International, Inc.), or a nickel-chromium-cobalt-titanium (NiCrCoTi) alloy (e.g., GTD 262 developed by General Electric Company).

As shown in FIG. 1, during operation of a conventional combustor 38, parts are exposed to a wide variety of extreme environmental conditions such as high temperature combustion, vibration, and chemical corrosion, e.g., oxidation. As also shown in FIG. 1, combustor 38 presents a number of potential life-limiting structures or features (see circled areas along welds 45, 47, 49, 56) that can reduce the life expectancy of combustor 38. For example, weld(s) 56 between tapered transition portion 46 and aft frame 52 can present a life-limiting structure of combustor 38 due to the high stress experienced at that location. Similarly, welds 45, 47, 49 may also present structures that reduce the life expectancy of combustor 38. Other life-limiting structures may include any other high stress geometry structures, hot spots, or other features that could cause a debit to the life of combustor 38.

In order to address these challenges, embodiments of the disclosure provide a combustor for a GT system that includes a combustor body including a (first) non-additively manufactured (non-AM) existing part having corrosion at a first level, i.e., from use of the combustor, and a (second) replacement additively manufactured (AM) part coupled to the first non-AM part. The second replacement AM part has corrosion at a second level less than the first level. The second replacement AM part replaces a removed non-AM part and, in some embodiments, includes at least an aft section of a tapered transition portion of a combustion liner and an aft frame of the combustor body. Due to the additive manufacturing, the replacement AM part includes a plurality of shared parallel, sintered metal layers extending into the replacement section (e.g., the aft section of the tapered transition portion and the aft frame).

The replacement AM part may also include a receiving element in a forwardmost end thereof configured to receive a rearwardmost remaining end of the non-AM existing part. The replacement AM part may also optionally include additional parts of the combustor such as an AFS injector mount and part of a cylindrical portion of the combustion liner. In other embodiments, the replacement AM part may include an AFS injector mount, part of a cylindrical portion of the combustion liner upstream from the AFS injector mount, and part of the tapered transition portion downstream from the AFS injector mount (perhaps including the aft frame). In embodiments where the replacement AM part does not extend fully to the aft frame, the rearwardmost end of the replacement AM part may be provided with a receiving element to receive the remaining aft portion of the tapered transition portion.

The replacement AM part allows replacement/repair of an existing part with life-limiting structures, e.g., welds, high stress geometry, hot spots, or other factors that could cause shortening of life of the combustor. The replacement AM part can be made without the life-limiting structures, such as welds, or with the life-limiting structures moved to a different, better location to increase combustor life. The replacement AM part may also be made with better materials than the removed non-AM part to increase combustor life. The replacement AM part is also less expensive to make compared to making the removed non-AM parts as described herein.

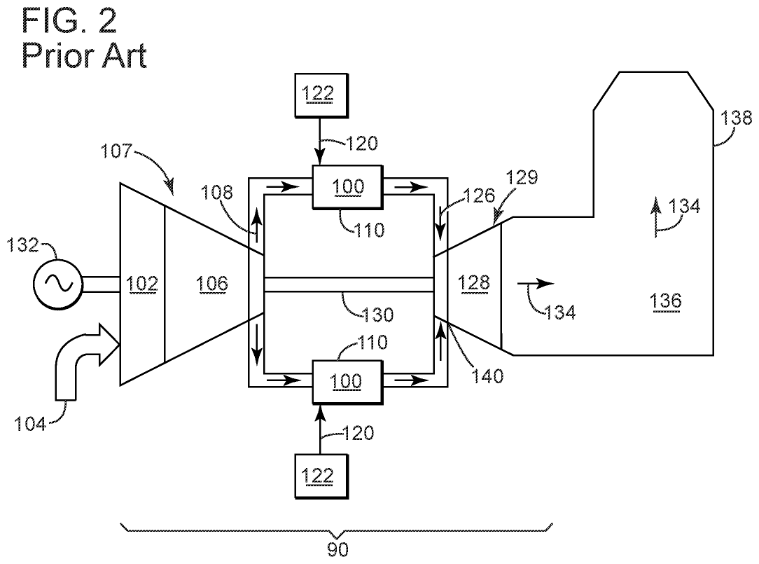

FIG. 2 shows a functional block diagram of an illustrative gas turbine (GT) system 90 that may incorporate various embodiments of a combustor 100 of the present disclosure. As shown, GT system 90 generally includes an inlet section 102 that may include a series of filters, cooling coils, moisture separators, and/or other devices to purify and otherwise condition a working fluid (e.g., air) 104 entering GT system 90. Working fluid 104 flows to a compressor 106 in a compressor section 107 that progressively imparts kinetic energy to working fluid 104 to produce a compressed air 108 (hereafter “air 108” or “compressed air 108”) at a highly energized state. Compressed air 108 is mixed with a fuel 120 from a fuel supply 122 to form a combustible mixture within at least one combustor 100 in a combustion section 110 that is operatively coupled to compressor section 107. The combustible mixture is burned to produce combustion gases 126 having a high temperature and pressure.

Combustion gases 126 flow through a turbine 128 (e.g., an expansion turbine) of a turbine section 129 operatively coupled to combustion section 110 to produce work. For example, turbine 128 may be connected to a shaft 130 so that rotation of turbine 128 drives compressor 106 to produce compressed air 108. Alternately, or in addition, shaft 130 may connect turbine 128 to a generator 132 for producing electricity. Exhaust gases 134 from turbine 128 flow through an exhaust section 136 that connects turbine 128 to an exhaust stack 138 downstream from turbine 128. Exhaust section 136 may include, for example, a heat recovery steam generator (not shown) for cleaning and extracting additional heat from exhaust gases 134 prior to release to the environment. Where more than one combustor 100 is used, they may be circumferentially spaced around a turbine inlet 140 of turbine 128.

In one embodiment, GT system 90 may include a commercially available engine model from GE Vernova of Cambridge, MA. The present disclosure is not limited to any one particular GT system and may be implanted in connection with engines including, for example, the HA, F, B, LM, GT, TM and E-class engine models of GE Vernova, and engine models of other companies. Furthermore, the present disclosure is not limited to any particular turbomachine, and may be applicable to, for example, steam turbines, jet engines, compressors, turbofans, etc.

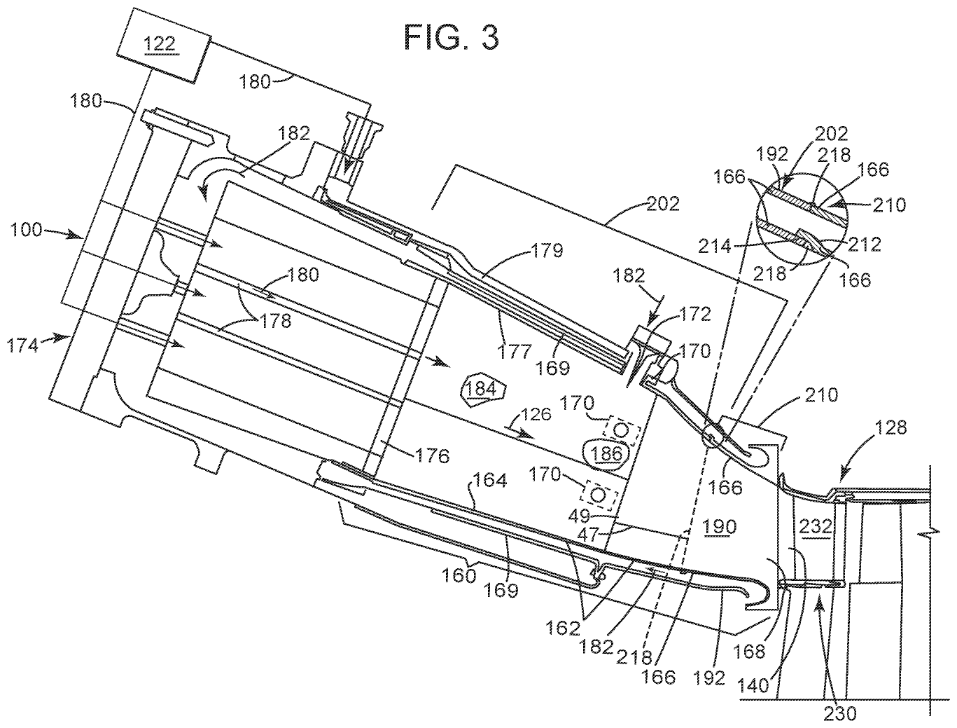

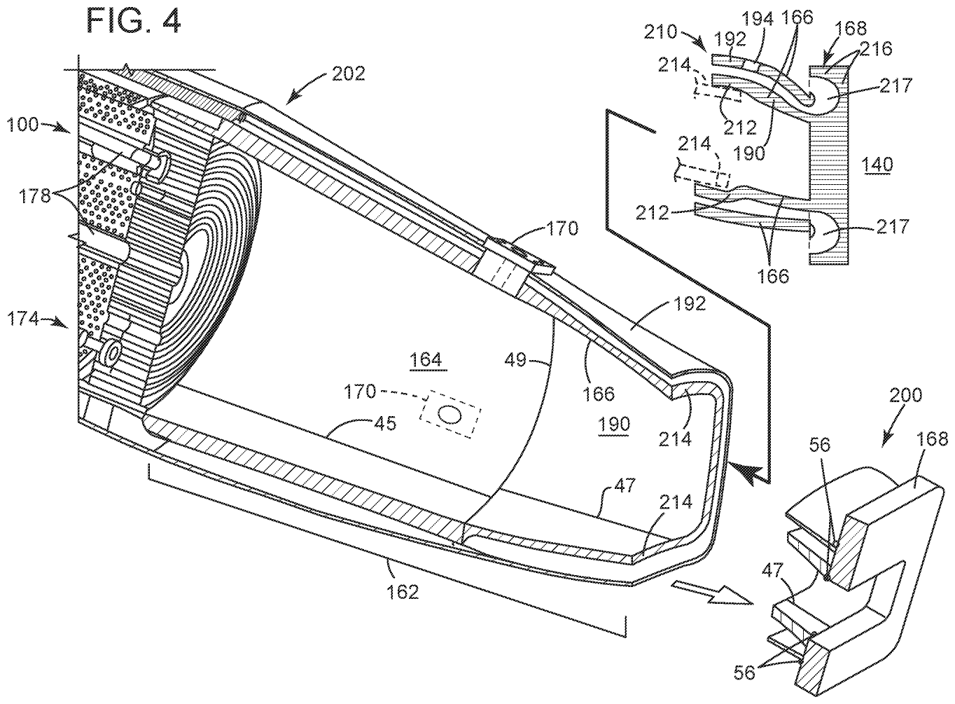

FIG. 3 shows a cross-sectional side view, and FIG. 4 shows a cross-sectional perspective and exploded view of a combustor 100 including a component (replacement AM part 210) according to embodiments of the disclosure.

With reference to FIGS. 3-4, embodiments of the disclosure may include a method of repairing a combustor 38 (FIG. 1). As shown in FIG. 3, a to-be repaired combustor 100 includes much of the structure of combustor 38 (FIG. 1). Briefly, combustor 100 includes a combustor body 160 including a combustion liner 162 including a cylindrical portion 164 and a tapered transition portion 166, and an aft frame 168 coupled to an aft end (right end as shown) of tapered transition portion 166. A flow sleeve 169 may surround cylindrical portion 164 of combustion liner 162. Combustor 100 may also include axial fuel stage (AFS) injector mounts 170 for mounting AFS injectors 172 (FIG. 3). Combustor 100 may also include a head end fuel nozzle assembly 174 (hereafter “head end assembly 174”) and a cap assembly 176 coupled to a forward end 177 of combustor body 160. Head end assembly 174 generally includes at least one axially extending fuel nozzle 178 for delivering fuel 180 and compressed air 182 to a primary combustion zone 184 from axially extending fuel nozzles 178. AFS injectors 172 extend radially through combustion liner 162 downstream from axially extending fuel nozzle(s) 178. Fuel lines 179 for AFS injectors 172 may be mounted to an exterior of flow sleeve 169, or may be formed therein. Compressed air 182 may be routed to AFS injector(s) 172 to combine with fuel 180 for combustion in a secondary combustion zone 186 that is downstream from primary combustion zone 184.

As shown in FIG. 4, the method may include removing a non-AM existing part 200 of combustor body 160 after use of the combustor. The removing step may include any now known or later developed process, e.g., cutting, machining, grinding, etc., sufficient to remove the desired parts. The removing step creates a removed non-AM part 200 and a remaining non-AM part 202 of combustor body 160. The removed non-AM part 200 may take a variety of forms. In certain embodiments, as shown in FIG. 4, removed non-AM part 200 includes at least an aft section of tapered transition portion 166 and aft frame 168 of combustor body 160. That is, some amount of an aft section of tapered transition portion 166 is removed, i.e., forward or upstream of its downstream aft end, and an entirety of aft frame 168 is removed.

The extent of the aft section of tapered transition portion 166 that is removed can be defined based on a number of factors. For example, a location of the cut can be selected to ensure a desired interface for a new part is provided. Notably, the location of the cut can be made to remove as many life-limiting structures as possible from combustor body 160. Hence, the removed non-AM part 200 may include at least one life-limiting structure such as but not limited to: weld 56, a known hot spot, and a high stress geometry. While FIGS. 3-4 show tapered transition portion 166 including an internal chamber 190 and an integral flow sleeve or impingement flow sleeve 192 (with holes therein, not shown) thereabout, it will be recognized that the flow sleeve, regardless of form, is optional.

This removal step may occur after use of combustor 100. During use of combustor 100, prior to the removing step, parts of combustor 100 experience corrosion commensurate with use. For example, combustion liner 162 may have oxidation, cracks, burn through, distortion, and/or creep thereon or therein. In any event, removed non-AM part 200 has corrosion thereon at a first level, e.g., commensurate with its material, environment exposed to, and duration of use of combustor 100. Hence, the level of corrosion and the type of corrosion may vary depending on removed non-AM part 200, among other things. While the first level of corrosion may vary, in one example, it may be represented by any level of use (including any of the aforementioned issues) to an extent beyond the part being new and up to and including where the corrosion may prevent the part from completing another combustion maintenance interval.

FIG. 4 also schematically shows additively manufacturing a replacement additively manufactured (AM) part 210 for removed non-AM part 200. The additive manufacturing process will be described later herein. In the exemplary illustration, replacement AM part 210 includes at least the aft section of tapered transition portion 166 and aft frame 168 of combustor body 160. That is, replacement AM part 210 includes at least the same parts as in removed non-AM part 200. Replacement AM part 210, however, does not include the at least one life-limiting structure found in removed non-AM part 200. In the FIG. 4 example, replacement AM part 210 does not include weld 56 because it is not required due to the additive manufacturing of the aft section of tapered transition portion 166 and aft frame 168 as an integral body. Further, replacement AM part 210 does not include part of weld 47 (see remaining non-AM part 202 in FIG. 4) that normally couples the longitudinal ends of stamped sections of tapered transition portion 166 because it is not required due to the additive manufacturing of the aft section of tapered transition portion 166. As a result of the additive manufacturing, there are no mechanical connections between the various parts (i.e., it is all one-piece).

The additive manufacture also allows replacement AM part 210 to be made of a different material than removed non-AM part 200 (FIG. 4). That is, removed non-AM part 200 (FIG. 4) may include a first material, and replacement AM part 210 may include a second material different than the first material. As noted herein, removed non-AM part 200 may be made of but is not limited to: HA282 or HA233, Inconel 625 or 718, Hastelloy X, or GTD 262. In contrast, replacement AM part 210 may be made of any non-reactive metal such as but not limited to: a cobalt chromium molybdenum (CoCrMo) alloy, stainless steel, an austenite nickel-chromium based alloy such as a nickel-chromium-molybdenum-niobium alloy (NiCrMoNb) (e.g., Inconel 625 or Inconel 718), a nickel-chromium-iron-molybdenum alloy (NiCrFeMo) (e.g., Hastelloy® X available from Haynes International, Inc.), or a nickel-chromium-cobalt-molybdenum alloy (NiCrCoMo) (e.g., Haynes 282 available from Haynes International, Inc.). Other possibilities include, for example, René 52, CM 247, Mar M 247 and any precipitation harden-able (PH) nickel alloy. The only limitation on the different metals is the need to be able to couple them together to make an operative combustor 100, e.g., through welding.

Replacement AM part 210 may also include a number of additional structures not found in removed non-AM part 200. Due to the additive manufacturing, replacement AM part 210 includes a plurality of parallel, sintered metal layers 216 that extends into at least the (new) aft section of tapered transition portion 166 and (new) aft frame 168. Replacement AM part 210 may also include a receiving element 212 configured to receive end 214 of remaining non-AM part 202 of combustor body 160. In the example shown in FIGS. 3-4, receiving element 212 includes a radially outward extending indent configured to receive end 214 of remaining non-AM part 202 in the form of a cut end thereof, i.e., in a male-female fit. It will be recognized that receiving element 212 can include a wide variety of alternative structures to receive end 214 of remaining non-AM part 202 such as but not limited to: a forked element, a radially inward extending indent or a simple butt joint interface.

Replacement AM part 210 may also include any variety of additional cooling passages therein. That is, replacement AM part 210 may include at least one cooling passage defined therein, which is not found in removed non-AM part 200. In one non-limiting example shown in FIGS. 3-4, aft frame 168 includes a new cooling passage 217 therein. In another example, where flow sleeve or impingement flow sleeve 192 is not present around interior chamber 190 of tapered transition portion 166 in removed non-AM part 200, it may be added to tapered transition portion 166 in replacement AM part 210. In another example, where flow sleeve or impingement flow sleeve 192 is present in removed non-AM part 200, the number, size, and/or positioning of the impingement openings 194 may be modified to direct cooling air (e.g., compressed air 118) to different areas of tapered transition portion 166. Replacement AM part 210 may also include any variety of other advantageous structures found in present-day, new build combustors, but not present in previously built combustors.

FIG. 3 shows coupling replacement AM part 210 to remaining non-AM part 202 of combustor body 160. The coupling may include welding replacement AM part 210 to remaining non-AM part 202 of combustor body 160 where rearwardmost remaining end 214 of remaining non-AM part 202 meets receiving element 212. The welding may include any now known or later developed welding process, e.g., TIG welding, MIG welding, etc., capable of permanently fixing and/or sealing the parts together and based on the different materials of the parts. When complete, as shown in FIG. 3, combustor body 160 includes one or more weld(s) 218, see dashed line, that couple aft section of tapered transition portion 166 and aft frame 168 to remaining non-AM part 202 of combustor body 160. In contrast to weld 56, as shown in FIG. 1, at a sharp, high stress geometry between aft section of tapered transition portion 46 and aft frame 52, as shown in FIG. 3, weld 218 is upstream in a linear location within tapered transition portion 166. This location reduces and possibly eliminates the life-decreasing nature of the weld.

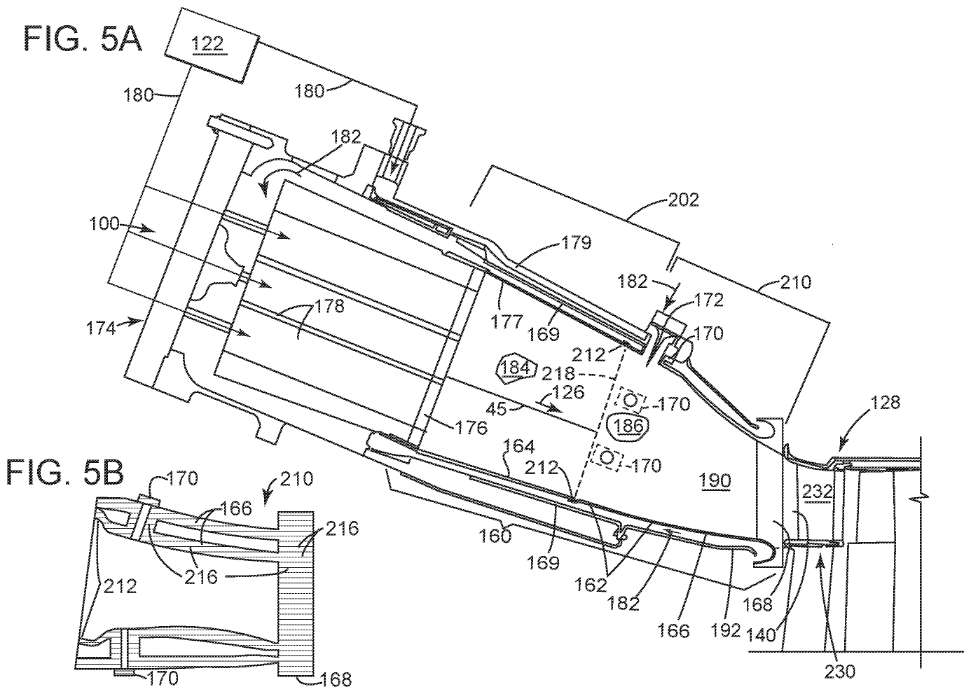

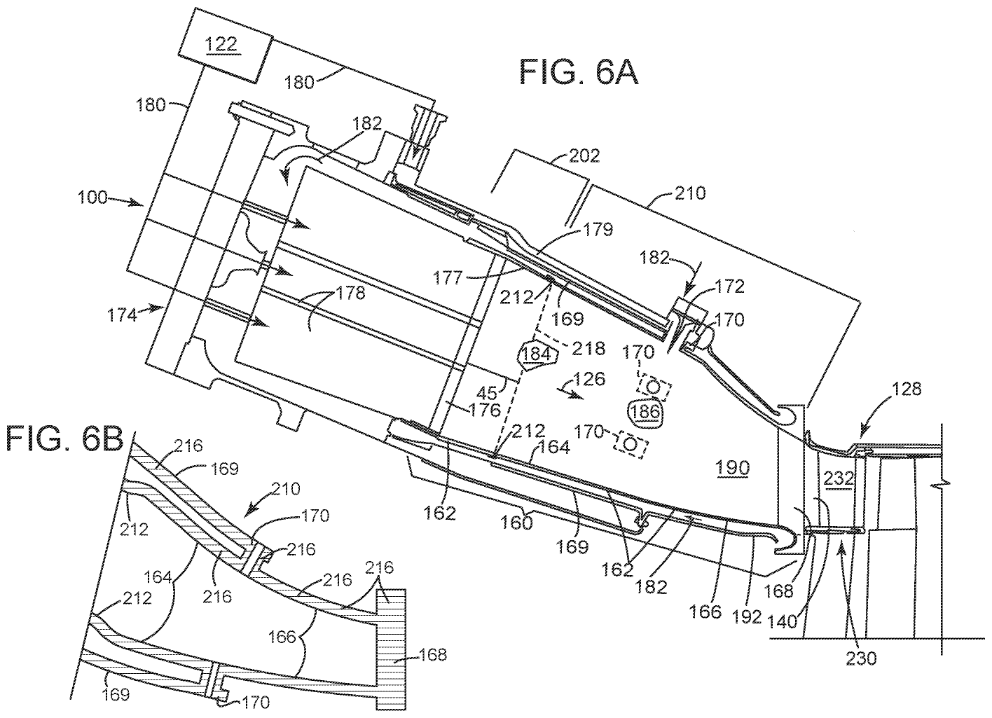

FIGS. 5A and 6A show cross-sectional views of combustor 100 according to alternative embodiments, and FIGS. 5B and 6B show cross-sectional views of replacement AM parts 210 for combustor 100 of FIGS. 5A and 6A, respectively. In these alternative embodiments, removed non-AM part 200 and replacement AM part 210 may include more of the aft section of combustor body 160. That is, the cut line for removed non-AM part 200 is farther left in the drawings (i.e., closer to head end assembly 174). For example, as shown in the cross-sectional view of FIGS. 5A-B, replacement AM part 210 further includes AFS injector mount(s) 170, and plurality of parallel, sintered metal layers 216 in replacement AM part 210 also extends into AFS injector mount(s) 170. Similarly, removed non-AM part 200 (not shown) may further include AFS injector mounts 170 upstream of tapered transition portion 166. In the FIGS. 5A-B example, replacement AM part 210 does not include weld 56 between tapered transition portion 166 and aft frame 168, as shown in FIGS. 1 and 4 (i.e., non-AM part 200), since the additive manufacturing of the aft section of tapered transition portion 166 and aft frame 168 eliminates the need for weld 56. Further, replacement AM part 210 in FIG. 5A-B does not include any of weld 47 (see FIGS. 1 and 4) that normally couples the longitudinal ends of stamped sections of tapered transition portion 166 because it is not required due to the additive manufacturing of the aft section of tapered transition portion 166. Additionally, weld 49 that normally couples tapered transition piece 166 and cylindrical portion 164 may be replaced by weld 218 similar to weld 218 described with respect to FIG. 3.

In another example, as shown in FIGS. 6A-B, replacement AM part 210 further includes part of cylindrical portion 164 of combustion liner 162 (to left of AFS injector mounts 170 as shown), and plurality of parallel, sintered metal layers 216 in replacement AM part 210 extends into the part of cylindrical portion 164 of combustion liner 162. Similarly, removed non-AM part (not shown) further includes a part of cylindrical portion 164 of combustion liner 162 upstream of AFS injector mount(s) 170. Replacement AM part 210 in FIG. 6A-B does not include any of weld 47 (see FIGS. 1 and 4) that normally couples the longitudinal ends of stamped sections of tapered transition portion 166, which is not required due to the additive manufacturing of the aft section of tapered transition portion 166. Additionally, weld 49 that normally couples tapered transition piece 166 and cylindrical portion 164 may be replaced by weld 218. Additionally, cylindrical portion of replacement AM part 210 in FIG. 6A-B does not include a corresponding portion of weld 45 (see FIG. 1) that normally couples the longitudinal ends of stamped sections of cylindrical portion 164, since the additive manufacturing of the part of cylindrical portion 164 eliminates the need for the downstream portion of weld 45.

While particular arrangements of replacement AM parts 210 have been illustrated and described herein, it is emphasized that replacement AM parts 210 may include any additional structure of combustor 100 capable of being additively manufactured. For example, replacement AM parts 210 may include any variety of flow sleeves, e.g., 169, cooling passages, AFS injector openings in combustor liner 162, fuel lines, and/or impingement flow sleeves, among other structures.

Embodiments of the disclosure may also include a component, i.e., previously described replacement AM part 210, for replacing removed non-AM part 200 of combustor body 160 for GT system 90. As noted, removed non-AM part 200 may include at least an aft section of tapered transition portion 166 and aft frame 168 of combustor body 160. The component includes replacement AM part 210, which may include at least the aft section of tapered transition portion 166 and aft frame 168. The component may also include receiving element 212 in a forwardmost end of replacement AM part 210 configured to receive a rearwardmost remaining end 214 of combustor body 160 after removal of removed non-AM part 200 and to join rearwardmost remaining end 214 of the combustor body 160 and forwardmost end of replacement AM part 210. The component may also include weld 218 coupling rearwardmost remaining end 214 of combustor body 160 and replacement AM part 210. As noted, removed non-AM part 200 may include a first material, and replacement AM part 210 may include a second material different than the first material.

In other embodiments, shown in FIGS. 5A-B, replacement AM part 210 of the component may further include AFS injector mount(s) 170 upstream of tapered transition portion 166, and plurality of parallel, sintered metal layers 216 in replacement AM part 210 may extend into AFS injector mount(s) 170. In other embodiments, shown in FIGS. 6A-B, replacement AM part 210 of the component may further include part of cylindrical portion 164 of combustion liner 162 upstream of AFS injector mount(s) 170, and plurality of parallel, sintered metal layers 216 in replacement AM part 210 may extend into the part of cylindrical portion 164. In other embodiments (not shown), replacement AM part 210 may include AFS injector mount(s) 170, part of a cylindrical portion 164 of combustion liner 162 upstream of AFS injector mount(s) 170, and part of tapered transition portion 166 downstream from AFS injector mount(s) 170 (perhaps including the aft frame 168). In embodiments where replacement AM part 210 does not extend fully to aft frame 168, the rearwardmost end of replacement AM part 210 may be provided with a receiving element 212 to receive the forwardmost end of remaining aft portion of the tapered transition portion 166.

Embodiments of the disclosure also include combustor 100 for GT system 90. As shown in FIGS. 3, 5A and 6A, combustor 100 includes combustor body 160 including combustion liner 162 including cylindrical portion 164 and tapered transition portion 166, AFS injector mount(s) 170, and aft frame 168 at an aft end of tapered transition portion 166. Combustor body 160 includes remaining non-AM part 202 having corrosion at a first level, i.e., from use of combustor 100, and a second replacement AM part 210 coupled to remaining non-AM part 202. Because replacement AM part 210 is formed after use of combustor 100 and replaces a part thereof, replacement AM part 210 has corrosion at a second level less than the first level. As described herein, in various embodiments, replacement AM part 210 includes at least an aft section of tapered transition portion 166 and aft frame 168. Further, due to the additive manufacturing, replacement AM part 210 includes plurality of shared parallel, sintered metal layers 216 extending into the at least aft section of tapered transition portion 166 and aft frame 168. In other embodiments, shown in FIGS. 5A-B, replacement AM part 210 may further include AFS injector mount(s) 170, and plurality of parallel, sintered metal layers 216 in replacement AM part 210 may extend into AFS injector mount(s) 170. In other embodiments, shown in FIGS. 6A-B, replacement AM part 210 may further include part of cylindrical portion 164 of combustion liner 162, and plurality of parallel, sintered metal layers 216 in replacement AM part 210 may extend into the part of cylindrical portion 164.

Replacement AM part 210 of combustor 100 may also include receiving element 212 configured to receive end 214 of remaining non-AM part 202 and to join remaining non-AM part 202 and replacement AM part 210, as previously described herein. As noted, weld 218 couples remaining non-AM part 202 and replacement AM part 210. Further, as described herein, remaining non-AM part 202 may include a first material and replacement AM part 210 may include a second material different than the first material. As shown in FIG. 4, replacement AM part 210 may include at least one cooling passage 217 defined therein, which is not present in removed non-AM part 200.

As shown in FIGS. 3, 5A and 6A, combustor 100 generally terminates at a point that is adjacent to a first stage 230 of stationary nozzles 232 of turbine 128. First stage 230 of stationary nozzles 232 at least partially defines turbine inlet 140 to turbine 128. Combustion liner 162 at least partially defines a hot gas path (HGP) for routing combustion gases 126 from primary combustion zone 184 and secondary combustion zone 186 to turbine inlet 140 of turbine 128 during operation of GT system 90.

In operation, as shown in FIGS. 3, 5A and 6A, compressed air 182 flows from compressor 106 and is routed through various fluid flow passage(s). A portion of compressed air 182 is routed, e.g., through flow sleeve 169, to head end assembly 174 of combustor 100, where it reverses direction and is directed through axially extending fuel nozzle(s) 178. Compressed air 182 is mixed with fuel 180 to form a first combustible mixture that is injected into primary combustion zone 184. The first combustible mixture is burned to produce combustion gases 126. A second portion of compressed air 182 may be routed through the radially extending AFS injectors 172 where it is mixed with fuel 180 from fuel passages 179 (e.g., conduits from fuel source 122 provided as external tubes (shown) or in flow sleeve(s) 169) to form a second combustible mixture. The second combustible mixture is injected through liner 162 and into the hot gas path (HGP). The second combustible mixture at least partially mixes with combustion gases 126 and is burned in secondary combustion zone 186. Combustion liner 162 at least partially defines hot gas path (HGP) for routing combustion gases 126 from primary combustion zone 184 and secondary combustion zone 186 to turbine inlet 140 of turbine 128 during operation of GT system 90.

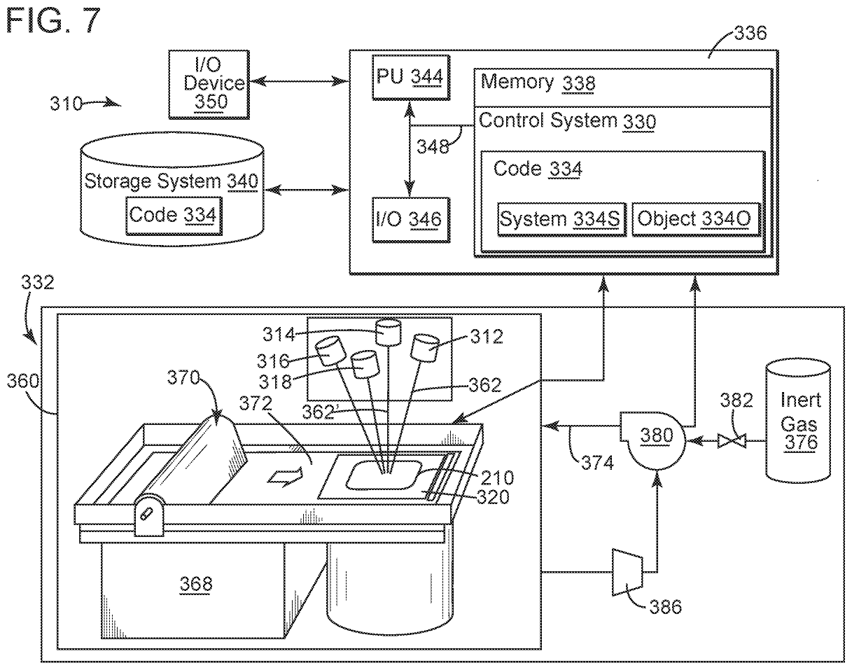

Replacement AM part 210 may be additively manufactured using any now known or later developed technique capable of forming the large, integral body. As shown in FIGS. 4, 5B and 6B, replacement AM part 210 includes a plurality of parallel, sintered metal layers 216 of the selected metal. FIG. 7 shows a schematic/block view of an illustrative computerized metal powder additive manufacturing system 310 (hereinafter ‘AM system 310’) for generating replacement AM part 210, of which only a single layer is shown. The teachings of the disclosures will be described relative to building replacement AM part 210 using multiple melting beam sources 312, 314, 316, 318, but it is emphasized and will be readily recognized that the teachings of the disclosure are equally applicable to build replacement AM part 210 using any number of melting beam sources.

In this example, AM system 310 is arranged for direct metal laser melting (DMLM). It is understood that the general teachings of the disclosure are equally applicable to other forms of metal powder additive manufacturing such as but not limited to selective laser melting (SLM), and perhaps other forms of additive manufacturing (i.e., other than metal powder applications). The layer of replacement AM part 210 in build platform 320 is illustrated in FIG. 7 as an oblong arcuate polygon (like a cross-section of tapered transition portion 166); however, it is understood that the additive manufacturing process can be readily adapted to manufacture any shaped part of replacement AM part 210 on build platform 320. Moreover, in the exemplary embodiments described herein, the cross-sectional shape may transition from an oblong arcuate polygon to a circular shape (e.g., in cylindrical portion 164 of combustor body 104).

AM system 310 generally includes an additive manufacturing control system 330 (“control system”) and an AM printer 332. As will be described, control system 330 executes set of computer-executable instructions or code 334 to generate replacement AM part 210 using multiple melting beam sources 312, 314, 316, 318. In the example shown, four melting beam sources may include four lasers. However, the teachings of the disclosures are applicable to any melting beam source, e.g., an electron beam, laser, etc. Control system 330 is shown implemented on computer 336 as computer program code. To this extent, computer 336 is shown including a memory 338 and/or storage system 340, a processor unit (PU) 344, an input/output (I/O) interface 346, and a bus 348. Further, computer 336 is shown in communication with an external I/O device/resource 350.

In general, processor unit (PU) 344 executes computer program code 334 that is stored in memory 338 and/or storage system 340. While executing computer program code 334, processor unit (PU) 344 can read and/or write data to/from memory 338, storage system 340, I/O device 350 and/or AM printer 332. Bus 348 provides a communication link between each of the components in computer 336, and I/O device 350 can comprise any device that enables a user to interact with computer 336 (e.g., keyboard, pointing device, display, etc.).

Computer 336 is only representative of various possible combinations of hardware and software. For example, processor unit (PU) 344 may comprise a single processing unit or be distributed across one or more processing units in one or more locations, e.g., on a client and server. Similarly, memory 338 and/or storage system 340 may reside at one or more physical locations. Memory 338 and/or storage system 340 can comprise any combination of various types of non-transitory computer readable storage medium including magnetic media, optical media, random access memory (RAM), read only memory (ROM), etc. Computer 336 can comprise any type of computing device such as an industrial controller, a network server, a desktop computer, a laptop, a handheld device, etc.

As noted, AM system 310 and, in particular control system 330, executes code 334 to generate replacement AM part 210. Code 334 can include, among other things, a set of computer-executable instructions 334S (herein also referred to as ‘code 334S’) for operating AM printer 332 as a system, and a set of computer-executable instructions 334O (herein also referred to as ‘code 334O’) for defining respective objects, such as replacement AM part 210 to be physically generated by AM printer 332. As described herein, additive manufacturing processes begin with a non-transitory computer readable storage medium (e.g., memory 338, storage system 340, etc.) storing code 334. Set of computer-executable instructions 334S for operating AM printer 332 may include any now known or later developed software code capable of operating AM printer 332.

The set of computer-executable instructions 334O defining replacement AM part 210 may include a precisely defined 3D model of replacement AM part 210 and can be generated from any of a large variety of well-known computer aided design (CAD) software systems such as AutoCAD®, TurboCAD®, DesignCAD 3D Max, etc. In this regard, code 334O can include any now known or later developed file format. Furthermore, code 334O representative of replacement AM part 210 may be translated between different formats. For example, code 334O may include Standard Tessellation Language (STL) files, which were created for stereolithography CAD programs of 3D Systems, or an additive manufacturing file (AMF), which is an American Society of Mechanical Engineers (ASME) standard that is an extensible markup-language (XML) based format designed to allow any CAD software to describe the shape and composition of any three-dimensional object to be fabricated on any AM printer. Code 334O representative of replacement AM part 210 may also be converted into a set of data signals and transmitted, received as a set of data signals and converted to code, stored, etc., as necessary. Code 334O may be configured according to embodiments of the disclosure to allow for formation of border and internal sections in overlapping field regions, as will be described. In any event, code 334O may be an input to AM system 310 and may come from a part designer, an intellectual property (IP) provider, a design company, the operator or owner of AM system 310, or from other sources. In any event, control system 330 executes code 334S and 334O, dividing replacement AM part 210 into a series of thin slices that assembles using AM printer 332 in successive layers of material.

AM printer 332 may include a processing chamber 360 that is sealed to provide a controlled atmosphere for replacement AM part 210 printing. A build platform 320, upon which replacement AM part 210 is/are built, is positioned within processing chamber 360. A number of melting beam sources 312, 314, 316, 318 are configured to melt layers of metal powder on build platform 320 to generate replacement AM part 210. While four melting beam sources 312, 314, 316, 318 are illustrated, it is emphasized that the teachings of the disclosure are applicable to a system employing any number of sources, e.g., 1, 2, 3, or 5 or more. As understood in the field, each melting beam source 312, 314, 316, 318 may have a field including a non-overlapping field region, respectively, in which it can exclusively melt metal powder, and may include at least one overlapping field region in which two or more sources can melt metal powder. In this regard, each melting beam source 312, 314, 316, 318 may generate a melting beam, respectively, that fuses particles for each slice, as defined by code 334O.

For example, in FIG. 7, melting beam source 312 is shown creating a layer of replacement AM part 210 using melting beam 362 in one region, while melting beam source 314 is shown creating a layer of replacement AM part 210 using melting beam 362′ in another region. Each melting beam source 312, 314, 316, 318 is calibrated in any now known or later developed manner. That is, each melting beam source 312, 314, 316, 318 has had its laser or electron beam's anticipated position relative to build platform 320 correlated with its actual position in order to provide an individual position correction (not shown) to ensure its individual accuracy. In one embodiment, each of plurality melting beam sources 312, 314, 316, 318 may create melting beams, e.g., 362, 362′, having the same cross-sectional dimensions (e.g., shape and size in operation), power and scan speed.

Continuing with FIG. 7, an applicator (or re-coater blade) 370 may create a thin layer of raw material 372 spread out as the blank canvas from which each successive slice of the final replacement AM part 210 will be created. Various parts of AM printer 332 may move to accommodate the addition of each new layer, e.g., a build platform 320 may lower and/or chamber 360 and/or applicator 370 may rise after each layer. The process may use different raw materials in the form of fine-grain metal powder, a stock of which may be held in a chamber or powder reservoir 368 accessible by applicator 370.

Processing chamber 360 is filled with an inert gas such as argon or nitrogen and controlled to minimize or eliminate oxygen. Control system 330 is configured to control a flow of a gas mixture 374 within processing chamber 360 from a source of inert gas 376. In this case, control system 330 may control a pump 380, and/or a flow valve system 382 for inert gas to control the content of gas mixture 374. Flow valve system 382 may include one or more computer controllable valves, flow sensors, temperature sensors, pressure sensors, etc., capable of precisely controlling flow of the particular gas. Pump 380 may be provided with or without valve system 382. Where pump 380 is omitted, inert gas may simply enter a conduit or manifold prior to introduction to processing chamber 360. Source of inert gas 376 may take the form of any conventional source for the material contained therein, e.g., a tank, reservoir or other source. Any sensors (not shown) required to measure gas mixture 374 may be provided. Gas mixture 374 may be filtered using a filter 386 in a conventional manner.

In operation, build platform 320 with metal powder thereon is provided within processing chamber 360, and control system 330 controls flow of gas mixture 374 within processing chamber 360 from source of inert gas 376. Control system 330 also controls AM printer 332, and in particular, applicator 370 and melting beam sources 312, 314, 316, 318 to sequentially melt layers of metal powder on build platform 320 to generate replacement AM part 210 according to embodiments of the disclosure. While a particular AM system 310 has been described herein, it is emphasized that the teachings of the disclosure are not limited to any particular additive manufacturing system or method.

As described herein, once replacement AM part 210 is formed, as shown in FIGS. 3, 5A and 6A, it may be coupled to remaining non-AM part 202. For example, replacement AM part 210 may be fitted to remaining non-AM part 202 (e.g., using features such as receiving end 212) and welded thereto.

The disclosure provides various technical and commercial advantages, examples of which are discussed herein. The replacement AM part allows replacement/repair of an existing part with life-limiting structures, e.g., welds, high stress geometry, hot spots, or other factor that could cause shortening of life of the combustor. The replacement AM part can be made without the life-limiting structures, such as welds, or with the life-limiting structures moved to a different, better locations to increase combustor life. The replacement AM part can be made with improved cooling features, which may be located in or localized in areas known to be hot spots. The replacement AM part may also be made with better materials than the removed non-AM part to increase combustor life and is less expensive to make compared to making the non-AM parts.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately” or “about,” as applied to a particular value of a range, applies to both end values and, unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application of the technology and to enable others of ordinary skill in the art to understand the disclosure for contemplating various modifications to the present embodiments, which may be suited to the particular use contemplated.

What is claimed is:

1. A method of repairing a combustor including a combustor body including a combustion liner including a cylindrical portion and a tapered transition portion, and an aft frame coupled to an aft end of the tapered transition portion, the method comprising:
removing a non-additively manufactured (non-AM) part of the combustor body, creating a removed non-AM part and a remaining non-AM part of the combustor body, wherein the removed non-AM part includes at least an aft section of the tapered transition portion and the aft frame of the combustor body;
additively manufacturing a replacement additively manufactured (AM) part for the removed non-AM part, the replacement AM part including a receiving element configured to receive part of the remaining non-AM part of the combustor body and a plurality of parallel, sintered metal layers, wherein the replacement AM part includes at least the aft section of the tapered transition portion and the aft frame of the combustor body; and
coupling the replacement AM part to the remaining non-AM part of the combustor body.

2. The method of claim 1, wherein the removed non-AM part includes at least one life-limiting structure selected from a group comprising: a weld, a hot spot, and a high stress geometry.

3. The method of claim 1, wherein the coupling includes welding the replacement AM part to the remaining non-AM part of the combustor body where the remaining non-AM part meets the receiving element.

4. The method of claim 1, wherein the replacement AM part includes at least one cooling passage defined therein that was not present in the removed non-AM part.

5. The method of claim 1, wherein the plurality of parallel, sintered metal layers in the replacement AM part extends into the aft section of the tapered transition portion and the aft frame.

6. The method of claim 5, wherein the removed non-AM part further includes an axial fuel stage (AFS) injector mount upstream of the tapered transition portion; and wherein the replacement AM part further includes the AFS injector mount, and the plurality of parallel, sintered metal layers in the replacement AM part extends into the AFS injector mount.

7. The method of claim 6, wherein the removed non-AM part further includes a part of the cylindrical portion of the combustion liner upstream of the AFS injector mount; and wherein the replacement AM part further includes the part of the cylindrical portion of the combustion liner, and the plurality of parallel, sintered metal layers in the replacement AM part extends into the part of the cylindrical portion of the combustion liner.

8. The method of claim 1, wherein the removed non-AM part includes a first material, and the replacement AM part includes a second material different than the first material.

9. A combustor for a gas turbine (GT) system, the combustor comprising:
a combustor body including a combustion liner including a cylindrical portion and a tapered transition portion, an axial fuel stage (AFS) injector mount, and an aft frame at an aft end of the tapered transition portion;
wherein the combustor body includes a first, non-additively manufactured (non-AM) part having corrosion at a first level and a second additively manufactured (AM) part coupled to the first non-AM part, the second AM part having corrosion at a second level less than the first level,
wherein the second AM part includes at least an aft section of the tapered transition portion and the aft frame, and a plurality of shared parallel, sintered metal layers extending into the at least aft section of the tapered transition portion and the aft frame.

10. The combustor of claim 9, wherein the second AM part includes a receiving element configured to receive part of the first non-AM part and to join the first non-AM part and the second AM part.

11. The combustor of claim 9, further comprising a weld coupling the first non-AM part and the second AM part.

12. The combustor of claim 9, wherein the first non-AM part includes a first material, and the second AM part includes a second material different than the first material.

13. The combustor of claim 9, wherein the second AM part includes at least one cooling passage defined therein.

14. The combustor of claim 9, wherein the second AM part further includes the AFS injector mount, and the plurality of parallel, sintered metal layers in the second AM part extends into the AFS injector mount.

15. The combustor of claim 14, wherein the second AM part further includes a part of the cylindrical portion of the combustion liner, and the plurality of parallel, sintered metal layers in the second AM part extends into the part of the cylindrical portion of the combustion liner.

16. A component for replacing a first non-additively manufactured (non-AM) part of a combustor body for a gas turbine (GT) system, the first non-AM part including at least an aft section of a tapered transition portion and an aft frame of the combustor body, the component comprising:
a second additively manufactured (AM) part including at least the aft section of the tapered transition portion and the aft frame, and a receiving element in a forwardmost end of the second AM part configured to receive a rearwardmost remaining end of the combustor body after removal of the first non-AM part and to join the rearwardmost remaining end of the combustor body and the forwardmost end of the second AM part.

17. The component of claim 16, further comprising a weld coupling a remaining portion of the combustor body and the second AM part.

18. The component of claim 16, wherein the first non-AM part includes a first material, and the second AM part includes a second material different than the first material.

19. The component of claim 16, wherein the replacement AM part further includes an axial fuel stage (AFS) injector mount of the combustor body upstream of the tapered transition portion; and wherein the plurality of parallel, sintered metal layers in the replacement AM part extends into the AFS injector mount.

20. The component of claim 19, wherein the second AM part further includes a part of a cylindrical portion of a combustion liner of the combustor body upstream of the AFS injector mount; and wherein the plurality of parallel, sintered metal layers in the replacement AM part extends into the part of the cylindrical portion of the combustion liner.
